(19) United States
(12) Patent Application Publication
(10) Pub. No.: US 2014/0165355 A1
(43) Pub. Date: Jun. 19, 2014

(54) JIG MANIPULATOR

(71) Applicants: Tim Smith, Uniontown, OH (US); Harrie A. Size, Akron, OH (US); Udo E. Beyersdorff, Hudson, OH (US)

(72) Inventors: Tim Smith, Uniontown, OH (US); Harrie A. Size, Akron, OH (US); Udo E. Beyersdorff, Hudson, OH (US)

(73) Assignee: SMITH TRUCK CRANE & EQUIPMENT, INC., Cuyahoga Falls, OH (US)

(21) Appl. No.: 14/132,798

(22) Filed: Dec. 18, 2013

Related U.S. Application Data
(60) Provisional application No. 61/738,722, filed on Dec. 18, 2012.

(51) Int. Cl. B66C 1/10; B66C 13/04

(52) U.S. Cl. CPC B66C 1/10; B66C 13/04
USPC 29/283

(57) ABSTRACT

One or more techniques and/or systems are disclosed for a jig manipulator. The jig manipulator may comprise a crane engagement means that can be configured to engage with a crane such that the jig manipulator is structurally supported by the crane. The jig manipulator may also comprise a jig engagement means that can be configured to engage a component handling jig, such as a large oven door, such that the jig manipulator engaged with the component handling jig can support the component during maintenance, removal and/or replacement of the component.

### CROSS-REFERENCE TO RELATED APPLICATIONS

This application claims priority to Provisional Patent Application, U.S. Ser. No. 61/738,722, entitled JIG MANIPULATOR, filed Dec. 18, 2012, which is incorporated herein by reference.

### BACKGROUND

Large-scale furnace/oven systems often comprise one or more accesses used to access the interior of the system, such as for maintenance, charging, unloading, etc. An access typically comprises an access panel, such as a door, which may be opened to utilize the access and properly closed to seal the access. Occasionally, the panel door may be repaired and/or replaced, necessitating removal of the door from the furnace/oven. As one example, a coke oven can comprise a plurality of large oven access doors (e.g., each weighing 12,000 pounds), which may provide a challenge when attempting to remove them from the oven.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

As provided herein, a jig manipulator may be devised that facilitates removal of a large component, such as an oven door from a furnace/oven, such as by a crane. That is, for example, the jig manipulator may be engaged with the crane at a first end of the manipulator, and may be engaged with a component handling jig at a second end of the manipulator. In this example, a combination of the crane, the jig manipulator, and the jig attached to the manipulator can be used to manipulate, remove and/or replace the component, such as removal of an oven door on a furnace or oven.

In one implementation, the jig manipulator may comprise a first end and a second end. Further, the jig manipulator can comprise a crane engagement means, which is configured to engage with a crane such that the jig manipulator is structurally supported by the crane. Further, the jig manipulator may comprise a jig engagement means, which is configured to engage a component handling jig such that the jig manipulator engaged with the component handling jig can support a heavy component during its manipulation, removal and/or replacement.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

What is disclosed herein may take physical form in certain parts and arrangement of parts, and will be described in detail in this specification and illustrated in the accompanying drawings which form a part hereof and wherein:

FIG. 1 is a component diagram illustration of an example implementation of an exemplary jig manipulator as disclosed herein.

FIGS. 2A and 2B are component diagram illustrations of an example implementation of one or more portions of a jig manipulator, as disclosed herein, engaged with at least a portion of a crane, respectively illustrating a side and front angled view.

FIGS. 3A, 3B and 3C are component diagram illustrations of an example implementation of one or more portions of a jig manipulator as disclosed herein, respectively illustrating a side, rear, and top view.

FIGS. 4A, 4B, 4C and 4D are component diagram illustrations of an example implementation of one or more portions of a jig manipulator as disclosed herein, respectively illustrating a front, side, rear, and top view.

FIGS. 5A, 5B, 5C and 5D are component diagram illustrations of an example implementation of one or more portions of a jig manipulator as disclosed herein, respectively illustrating a top, rear, bottom, and side view.

FIG. 6 is a component diagram illustration of an example implementation of one or more portions of a jig manipulator as disclosed herein.

### DETAILED DESCRIPTION

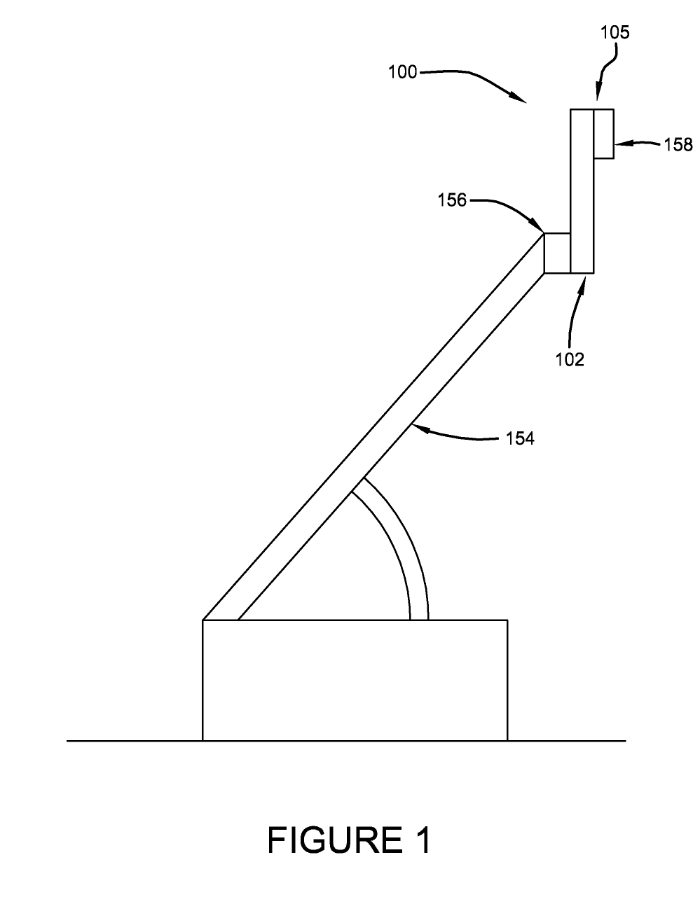

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices may be shown in block diagram form in order to facilitate describing the claimed subject matter. FIGS. 1-6 illustrate one or more implementations of one or more portions of the presently claimed subject matter.

In one aspect, a facility that utilizes large industrial systems, such as large ovens (e.g., and/or furnaces), may periodically manipulate components of the industrial systems, such as for maintenance, removal and/or replacement. As an example, large access panels (“doors”) on furnace of ovens may be removed for maintenance and/or replacement. As one example, in a coke (e.g., for steel) processing facility large coke ovens are used to process the coke at very high temperatures. Often, the coke ovens run in a long series and comprise a plurality of access panels that may be used for oven maintenance, charging, cleaning, product removal, etc., for example. In this example, the access panel doors can be lined with refractory ceramic material that may lose effectiveness over time, and may need to be replaced. In order to replace the refractory material, the access door is typically removed, where an oven doors can be up to twelve feet wide (e.g., or greater), and weigh up to approximately 12,000 pounds (e.g., or greater). A large door removal jig is commonly utilized to facilitate door removal, for example.

A jig manipulator may be devised to facilitate manipulation (e.g., removal) of a large industrial component, for example, where the jig manipulator can be attached to a component manipulation jig and engaged with an extension crane (e.g., a hydraulic crane). In this way, for example, the component manipulation jig can be manipulated safely, using the crane engaged with the jig manipulator, such that the component (e.g., oven door) may be effectively removed and/or replaced in a more efficient manner (e.g., than prior door removal techniques).

In one implementation, the jig manipulator comprises a crane engagement means 102, at a first end, where the crane engagement means 102 is configured to engage with at least a portion of a crane 154 such that the jig manipulator 100 is structurally supported by the crane, for example. For example, the crane engagement means 102 may be selectively coupled with a boom of a hydraulic crane. The jig manipulator 100 can further comprise a jig engagement means 105, at a second end, where the jig engagement means 105 is configured to engage a component handling jig. For example, the component handling jig may comprise a door handling jig that can engage, support, and manipulate a door (e.g., coke oven door) using a combination of the crane, jig manipulator and component handling jig, during removal and/or replacement of the door from the oven.

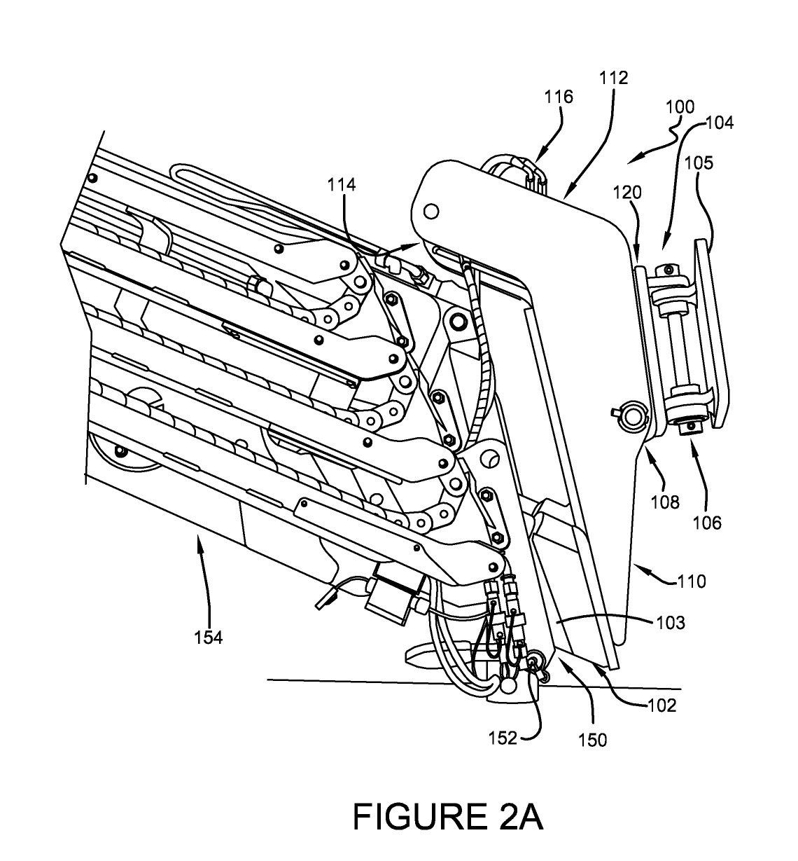

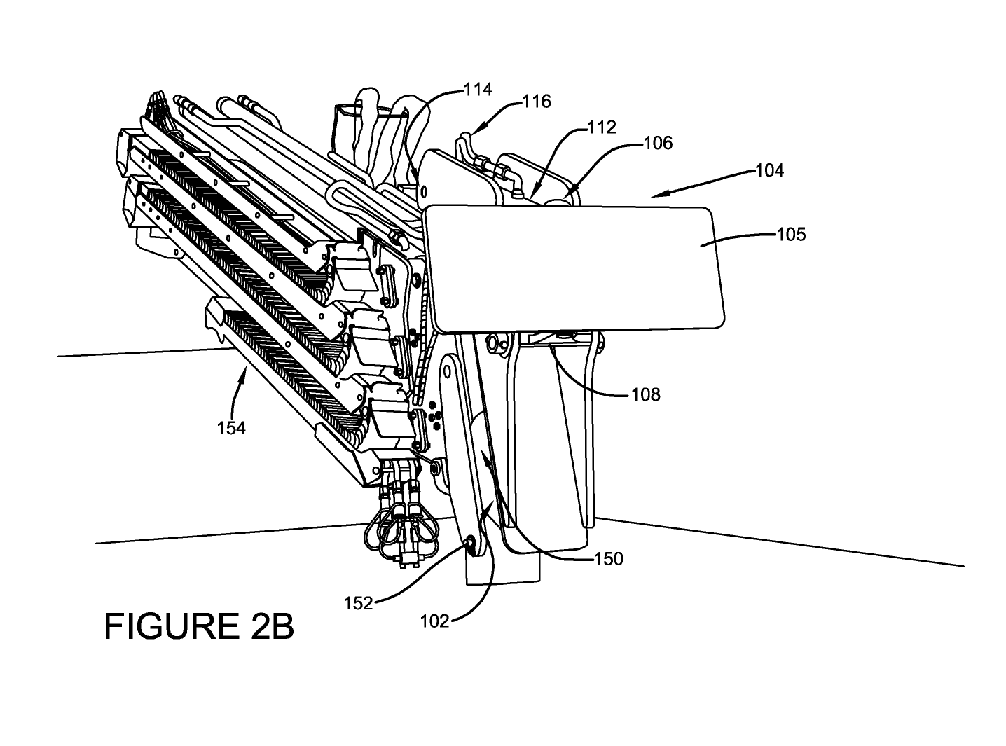

The jig manipulator may be further described with reference to the example implementations of FIGS. 2A and 2B. FIG. 2A is a side view of an example implementation of a jig manipulator 100 engaged with at least a portion of a crane 154. FIG. 2B is a front angled view of the example implementation of the jig manipulator 100 engaged with at least a portion of the crane 154. In this example implementation, a crane engagement component 102 (e.g., crane engagement means) can comprise an extension support 103 affixed (e.g., welded, fastened, etc.) to a structural support component 110 of the jig manipulator 100. The extension support 103 may comprise an elongated tube or beam (e.g., male connector portion) that is selectively engaged with, and extends into, an attachment receiving component 150 (e.g., a matching female receiving portion) of at least a portion of the crane 154. Further, as one example, the extension support 103 may be selectively engaged with the attachment receiving component 150 by way of a fastening pin 152 or any suitable fastening means (e.g., fastener, bolt, coupling, rivet, clamp, etc.) selected according to appropriate engineering principles.

In the example implementations of FIGS. 2A and 2B, the jig engagement means 105 may comprise a vertical rotation handler 104. In one implementation, the vertical rotation handler 104 can comprise a plate of suitable size and shape that may be affixed (e.g., welded, fastened, etc.) to a component handling jig (not shown). In another implementation, the plate of the vertical rotation handler 104 may be selectively engaged with the component handling jig (not shown), such as by fasteners, couplers, pins, bolts, etc. Further, the vertical rotation handler 104 (comprising the jig engagement means 105) may be in vertical rotatable engagement with a structural support component 110, of the jig manipulator 100, and may be configured to provide for adjustment of the yaw (e.g., rotation around a vertical axis) of a jig that is engaged with the jig engagement means 105.

In this example implementation, the vertical rotatable engagement formed between the vertical rotation handler 104 and the structural support component 110 may comprise a vertical rotatable axis 106 for the jig manipulator 100, for example, where a door handling jig (not shown) engaged with the vertical rotation handler 104 may be manipulated in vertical rotation (e.g., yaw, comprising movement from side to side) with respect to a face of a target door (e.g., intended for engagement with the door handling jig). In one implementation, the vertical rotatable axis 106 can provide a lateral range of motion (rotationally) to the vertical rotation handler 104 and attached door handling jig (not shown), where the lateral range of motion is selected according to appropriate engineering principles (e.g., based on expected weight capacities, tolerances, safety, etc.).

In the example implementations of FIGS. 1 and 2, the structural support component 110 may comprise a horizontal rotatable axis 108. That is, for example, the vertical rotation handler 104 may be in horizontal rotatable engagement with the structural support component 110 of the jig manipulator 100. As one example, a door handling jig (not shown) engaged with the vertical rotation handler 104 may be manipulated in horizontal rotation (e.g., up and down) with respect to a face of a target door (e.g., intended for engagement with the door handling jig). In this way, for example, a plane comprising the front face of the door handling jig (e.g., engaged with the vertical rotation handler 104) may be suitably matched to the plane of the door. In one implementation, the horizontal rotatable axis 108 can provide a horizontal range of motion (e.g., rotationally around the horizontal rotatable axis) to the vertical rotation handler 104 engaged with the attached door handling jig (not shown), where the horizontal range of motion is selected according to appropriate engineering principles (e.g., based on expected weight capacities, tolerances, safety, etc.).

In one implementation, the jig manipulator 100 may comprise a pitch adjustment component 112, such as a hydraulic cylinder component, operably engaged with the structural support component 110 at a first cylinder attachment point 114, and further engaged with a horizontal rotation handler 120 at a second cylinder attachment point 118. In one implementation, the pitch adjustment component 112 can be configured to adjust the horizontal rotation handler 120 around the horizontal rotatable axis 108. As an example, the pitch adjustment component 112 may be actuated to an out and/or in position by pressurized hydraulic fluid, supplied by hydraulic lines 116. As one example, when the pitch adjustment component 112 is actuated to the out position, the horizontal rotation handler 120 can be horizontally rotated in a clockwise direction around the horizontal rotatable axis 108. In this way, the vertical rotation handler 104 engaged with the door handling jig (not shown) may also be horizontally rotated in a clockwise direction (e.g., to match the plane face of the target door). Further, in this example, when the pitch adjustment component 112 is actuated to the in position, the horizontal rotation handler 120 can be horizontally rotated in a counter-clockwise direction around the horizontal rotatable axis 108.

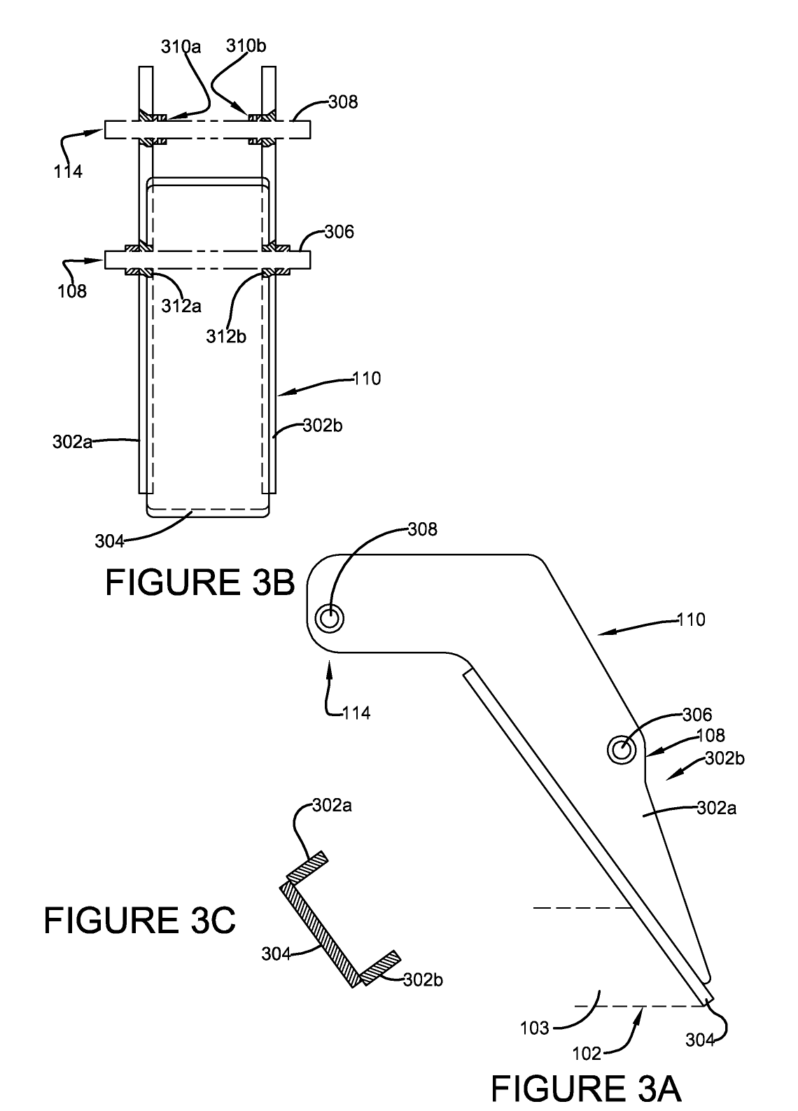

Now with reference to FIGS. 3-6, and continued reference to FIGS. 1, 2A and 2B, one or more portions of the exemplary jig manipulator are further described. FIGS. 3A, 3B and 3C are component diagram illustrations of an example implementation of one or more portions of a jig manipulator 100, as disclosed herein, respectively illustrating a side, front and top view of a portion of the jig manipulator 100. The structural support component 110 of the jig manipulator 100 can comprise a back structural member 304, a first side structural member 302a, and a second side structural member 302b. In one implementation, a shape and/or size of the structural member may be determined by a type, shape and size of a target crane, to which the jig manipulator 100 may be selectively coupled, and/or a type, shape and size of a target jig (e.g., and target door), to which the jig manipulator 100 may be selectively coupled. As one example (e.g., as illustrated in FIGS. 2A, 2B and 3A), the structural support component 110 of the jig manipulator 100 can comprise and an angled element, configured to be attached to the target crane 154, whereby the hydraulic cylinder 112 may be effectively sized and located to suitably manipulate the horizontal rotation handler 120.

In the exemplary implementations of FIGS. 3A, 3B, and 3C, the crane engagement means 102 (e.g., comprising an extension support 103 of FIGS. 2A) can be engaged with the structural support component 110. In one implementation, the crane engagement means 102 can be welded to a portion of the rear-facing surface of the structural support component 110. In another implementation, the crane engagement means 102 may be fastened to a portion of the rear-facing surface of the structural support component 110 using suitable fastening means (e.g., rivets, fasteners, bolts, etc.). In another implementation, the crane engagement means 102 may be integrally formed with a portion of the rear-facing surface of the structural support component 110 (e.g., cast, milled, extruded, stamped, pressed, etc.). In one implementation, the back structural member 304, first side structural member 302a, and second side structural member 302b may respectively be formed from a cold finished steel, such as a C1018 specified steel product. In other implementations, the back structural member 304, first side structural member 302a, and second side structural member 302b may respectively be formed from a suitable material selected by appropriate engineering practices for the desired use. As one example, a high-strength polymer (e.g., or polymer combination) may be utilize where high temperatures (e.g., from a coke oven) are not expected for the desired use.

As described above, the structural support component 110 can comprise a horizontal rotatable axis 108. The horizontal rotatable axis 108 may be formed by a first horizontal bushing 312a (e.g., comprising a first horizontal through hole) disposed in the first side structural member 302a and a second horizontal bushing 312b (e.g., comprising a second horizontal through hole) disposed in the second side structural member 302b. Further, a horizontal pivot pin 306 may be disposed along the horizontal rotatable axis 108 to selectively engage the horizontal rotation handler 120 (as shown in FIG. 1) with the first horizontal bushing 312a and the second horizontal bushing 312b of the horizontal rotatable axis 108. In one implementation, the horizontal pivot pin 306 may be formed from a cold finish steel product, such as a 4140/4140H specified cold finish steel product. In other implementations, the horizontal pivot pin 306 may be formed from a suitable material selected by appropriate engineering practices for the desired use, such as a high-strength polymer.

The structural support component 110 can comprise a first cylinder attachment point 114, to which a first side of a hydraulic cylinder 112 may be selectively engaged. The first cylinder attachment point 114 may be formed by a first cylinder attachment bushing 310a (e.g., comprising a first cylinder attachment through hole) disposed in the first side structural member 302a and a second cylinder attachment bushing 310b (e.g., comprising a second cylinder attachment through hole) disposed in the second side structural member 302b. Further, a first cylinder attachment pivot pin 308 may selectively engage the hydraulic cylinder 112 with the first horizontal bushing 310a and the second horizontal bushing 310b of the first cylinder attachment point 114.

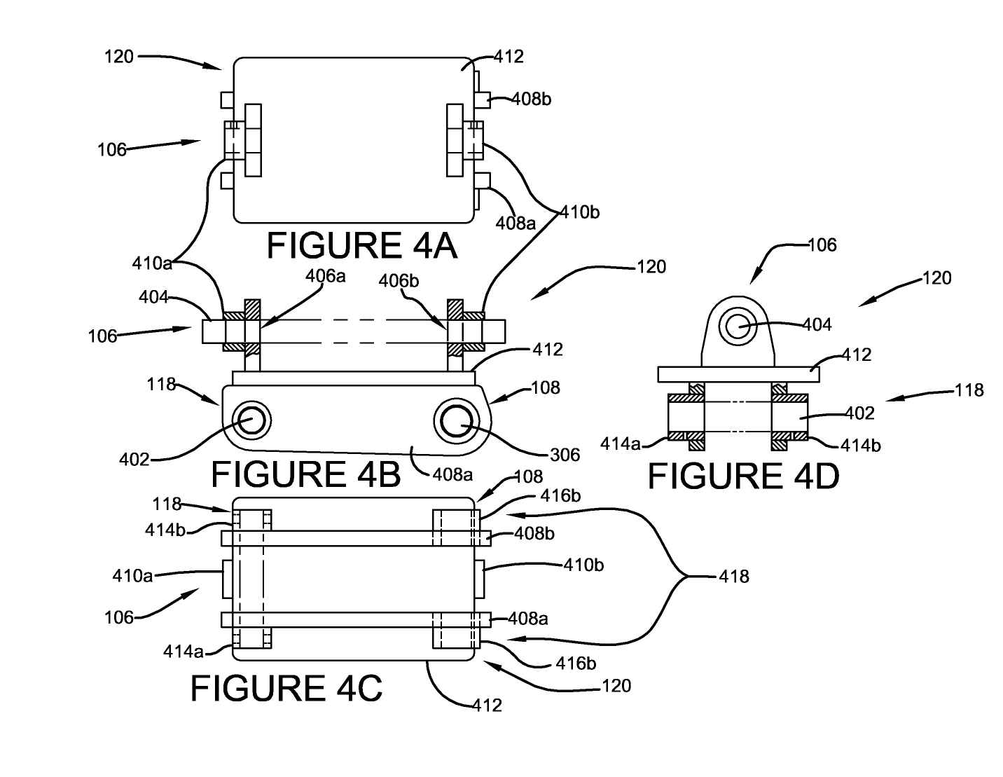

As illustrated in FIGS. 4A, 4B, 4C, and 4D, the horizontal rotation handler 120 can comprise a second cylinder attachment point 118. In this implementation, the hydraulic cylinder 112 can be selectively engaged with the second cylinder attachment point 118 using a second cylinder attachment pivot pin 402. Further, the second cylinder attachment pivot pin 402 can be engaged with the second cylinder attachment point 118 by a first horizontal rotation bushing 414a (e.g., comprising a first horizontal rotation through hole) and the second horizontal rotation bushing 414b (e.g., comprising a second horizontal rotation through hole). The first horizontal rotation bushing 414a can be disposed in a first horizontal rotation handler side plate 408a, and the second horizontal rotation bushing 414b can be disposed in a second horizontal rotation handler side plate 408b.

Further, the first horizontal rotation handler side plate 408a can comprise a third horizontal rotation bushing 416a (e.g., comprising a third horizontal rotation through hole), and the second horizontal rotation handler side plate 408b can comprise a fourth horizontal rotation bushing 416b (e.g., comprising a fourth horizontal rotation through hole). The third horizontal rotation bushing 416a and the fourth horizontal rotation bushing 416b can be configured to receive the horizontal pivot pin 306 in order to selectively engage the horizontal rotation handler 120 with the structural support component 110 in horizontal rotation. Further, in one implementation, the third horizontal rotation bushing 416a and the fourth horizontal rotation bushing 416b can comprise a horizontal pivot coupler 418, for example, in conjunction with the horizontal pivot pin 306, for selective coupling with the structural support component 110.

Additionally, the first horizontal rotation handler side plate 408a and the second horizontal rotation handler side plate 408b can respectively be attached (e.g., welded, fastened) to a horizontal rotation handler front plate 412. In one implementation, the respective first horizontal rotation handler side plate 408a and the second horizontal rotation handler side plate 408b may be attached in a parallel arrangement (as shown in FIG. 3), where the respective side plates 408 are attached to the back of the horizontal rotation handler front plate 412, orthogonally to the plane of the horizontal rotation handler front plate 412. In another implementation, the respective side plates 408 may be integrally formed with the back structural member 304 (e.g., cast, milled, extruded, stamped, pressed, etc.).

In one implementation, the first horizontal rotation handler side plate 408a, the second horizontal rotation handler side plate 408b, and the horizontal rotation handler front plate 412 may respectively be formed from a steel product, such as an ASTM A572 grade 50 specified steel product (e.g., having a minimum yield of 50 k.s.i.). In other implementations, the first horizontal rotation handler side plate 408a, the second horizontal rotation handler side plate 408b, and the horizontal rotation handler front plate 412 may respectively be formed from a suitable material selected by appropriate engineering practices for the desired use. As one example, a high-strength polymer (e.g., or polymer combination) may be utilize where high temperatures (e.g., from a coke oven) are not expected for the desired use.

In the example implementation of FIGS. 4A, 4B, 4C, and 4D, the horizontal rotation handler 120 can comprise a first top vertical rotation plate 406a and a first bottom vertical rotation plate 406b. The respective vertical rotation plates 406 may be attached to (e.g., welded to, fasted to, integrally formed with) the horizontal rotation handler front plate 412, such that the respective vertical rotation plates 406 transect the vertical rotation axis 106, relatively orthogonally to the axis of vertical rotation formed by the vertical rotation axis 106.

In one implementation, the respective vertical rotation plates 406 may be suitably sized and shaped in accordance with appropriate engineering principles for a desired use. In one implementation, the respective vertical rotation plates 406 may be formed from a steel product, such as an ASTM A572 grade 50 specified steel product (e.g., having a minimum yield of 50 k.s.i.). In other implementations, the respective vertical rotation plates 406 may be formed from a suitable material selected by appropriate engineering practices for the desired use. As one example, a high-strength polymer (e.g., or polymer combination) may be utilize where high temperatures (e.g., from a coke oven) are not expected for the desired use.

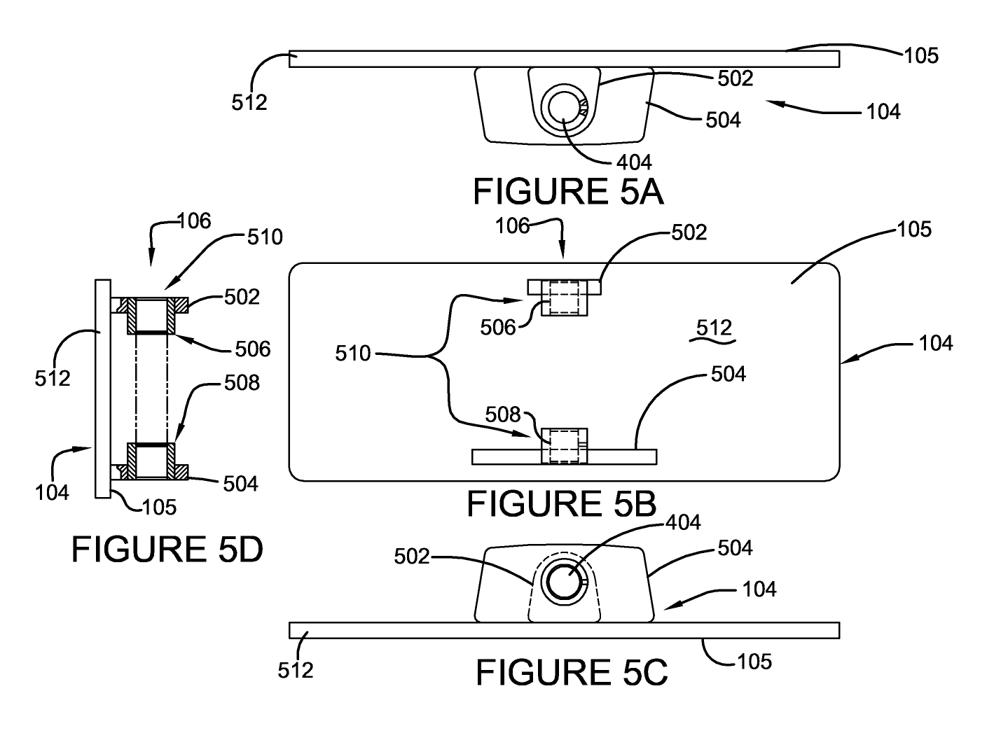

In the example implementation of FIGS. 4A, 4B, 4C, and 4D, the first top vertical rotation plate 406a can comprise a first vertical rotation bushing 410a (e.g., comprising a first vertical rotation through hole), and the first bottom vertical rotation plate 406b can comprise a second vertical rotation bushing 410b (e.g., comprising a second vertical rotation through hole). In one implementation, the first vertical rotation bushing 410a can be aligned along the vertical rotation axis 106 with the second vertical rotation bushing 410b, for example, such that a vertical rotation pin 404 may be selectively inserted through the respective vertical rotation bushings 410 (e.g., and associated vertical rotation through holes). For example, the first and second vertical rotation bushings 410 may be coupled with a vertical pivot coupler (e.g., 510 in FIG. 5, below), utilizing the vertical rotation pin 404.

As illustrated in FIGS. 5A, 5B, 5C, and 5D, the vertical rotation handler 104 can comprise a jig engagement means 105, which may comprises a vertical rotation handler front plate 512. As described above, the vertical rotation handler front plate 512 can comprise the jig engagement means 105. In one implementation, the vertical rotation handler front plate 512 can be sized and/or shaped to suitably engage with a desired jig (e.g., a door handling jig). In one implementation, the vertical rotation handler front plate 512 may be welded to the desired jig. In another implementation, the vertical rotation handler front plate 512 may be selectively fastened to the desired jig (e.g., using an appropriate fastener system, such nuts and bolts). As one example, a size and/or shape of the vertical rotation handler front plate 512, and/or method of attaching the vertical rotation handler front plate 512 to the desired jig may be selected using appropriate engineering principles for the desired use.

In the example implementation of FIGS. 5A, 5B, 5C, and 5D, a second top vertical rotation plate 502 is disposed at a top portion, in a relatively central location, of the vertical rotation handler front plate 512. Further, a second bottom vertical rotation plate 504 is disposed at a bottom portion, in a relatively central location, of the vertical rotation handler front plate 512. In one implementation, the second top vertical rotation plate 502 and second bottom vertical rotation plate 504 may be attached (e.g., welded, selectively fastened) to the vertical rotation handler front plate 512. In another implementation, the second top vertical rotation plate 502 and second bottom vertical rotation plate 504 may be integrally formed with the vertical rotation handler front plate 512.

In one implementation, the second top vertical rotation plate 502 and second bottom vertical rotation plate 504 may be suitably sized and/or shaped in accordance with appropriate engineering principles for a desired use. In one implementation, a size and/or shape of one or more of the first top vertical rotation plate 406a, first bottom vertical rotation plate 406b, second top vertical rotation plate 502, and second bottom vertical rotation plate 504 can determine a range of vertical rotation around the vertical rotation axis 106, for the vertical rotation handler 104.

As one example, a larger sized and suitably shaped second bottom vertical rotation plate 504, as illustrated in FIGS. 5A-5C, may provide a mechanical stop for the vertical rotation of the vertical rotation handler 104. In this example, the horizontal rotation handler front plate 412 may impact a portion of the second bottom vertical rotation plate 504, thereby limiting the angle of rotation around the vertical rotation axis 106, for example, mitigating over-rotation of the vertical rotation handler past a desired rotation angle. In one implementation, the angle of rotation around the vertical rotation axis 106 may be suitably determined (e.g., and implemented in a design of the respective rotation handler plates) by appropriate engineering principles for the desired use (e.g., based on a weight, size, shape, etc. of a door being handled by the door handling jig engaged with the jig engagement means). As one example, a desired angle of rotation around the vertical rotation axis 106 may comprise a total of three to five degrees to either side.

In one implementation, the second top vertical rotation plate 502, second bottom vertical rotation plate 504, and vertical rotation handler front plate 510 may be formed from a steel product, such as an ASTM A572 grade 50 specified steel product (e.g., having a minimum yield of 50 k.s.i.). In other implementations, the respective vertical rotation plates 406 may be formed from a suitable material selected by appropriate engineering practices for the desired use. As one example, a high-strength polymer (e.g., or polymer combination) may be utilize where high temperatures (e.g., from a coke oven) are not expected for the desired use.

In the example implementation of FIGS. 5A, 5B, 5C, and 5D, the second top vertical rotation plate 502 can comprise a third vertical rotation bushing 506 (e.g., comprising a third vertical rotation through hole), and the second bottom vertical rotation plate 504 can comprise a fourth vertical rotation bushing 508 (e.g., comprising a fourth vertical rotation through hole). In one implementation, the third vertical rotation bushing 506 can be aligned along the vertical rotation axis 106 with the fourth vertical rotation bushing 508, for example, such that a vertical rotation pin 404 may be selectively inserted through the respective vertical rotation bushings 410 (e.g., and associated vertical rotation through holes). In this implementation, for example, the vertical rotation pin 404 may be selectively inserted through the respective vertical rotation bushings 410, and through the third vertical rotation bushing 506 and fourth vertical rotation bushing 508 to attach the vertical rotation handler 104 to the horizontal rotation handler 120 (e.g., thereby engaging the vertical rotation handler 104, and attached jig, with the structural support component 110 and engaged crane 154). In one implementation, the combination of the third vertical rotation bushing 506 and fourth vertical rotation bushing 508, in combination with the vertical rotation pin 404, may comprise a vertical pivot coupler, for example, for coupling the vertical rotation handler 104 to the horizontal rotation handler 120.

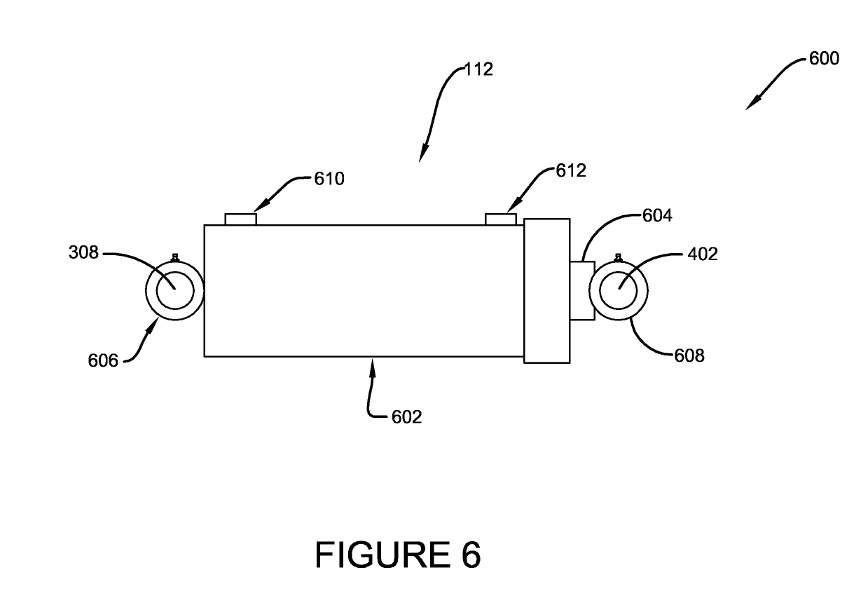

FIG. 6 is a component diagram illustrating an example implementation of one or more portions of a jig manipulator, as disclosed herein. In this example implementation, the pitch adjustment component 112 can comprise a hydraulic cylinder. In this implementation, the pitch adjustment component 112 can comprise a cylinder casing 602, engaged with (e.g., formed with, fastened to) a structural member engagement cap 606. The structural member engagement cap 606 can be configured to selectively engage with the first cylinder attachment pivot pin 308, for example, thereby attaching the hydraulic cylinder 112 to the structural support component 110 at the first cylinder attachment point 114.

Further, in this example implementation, the hydraulic cylinder 112 can comprise a cylinder piston rod or shaft 604, engaged with (e.g., formed with, fastened to) a horizontal rotation handler engagement eye 608. The horizontal rotation handler engagement eye 608 can be configured to selectively engage with the second cylinder attachment pivot pin 402, for example, thereby attaching the hydraulic cylinder 112 to the horizontal rotation handler 120 at the second cylinder attachment point 118.

Additionally, the in this example implementation, the hydraulic cylinder 112 can comprise a first hydraulic fluid port 610 and a second hydraulic fluid port 612. In one implementation, the respective hydraulic fluid ports 610, 612 may be engaged with a hydraulic line 116 (e.g., of FIGS. 1 and 2); where by the hydraulic lines can supply and/or vent hydraulic fluid from the respective hydraulic fluid ports 610, 612. In this way, for example, a hydraulic power supply may provide pressurized hydraulic fluid, provided via a hydraulic line 116, forced into the first hydraulic fluid port 610, which can cause the hydraulic cylinder to actuate the cylinder piston rod 604 out (e.g., while venting hydraulic fluid out of the second hydraulic fluid port 612). Further, in this example, pressurized hydraulic fluid, provided by a hydraulic line 116, forced into the second hydraulic fluid port 612, may cause the hydraulic cylinder to actuate the cylinder piston rod 604 in (e.g., while venting hydraulic fluid out of the first hydraulic fluid port 610).

In one implementation, as described above, when the hydraulic cylinder 112 is actuated to the out position, the horizontal rotation handler 120 can be horizontally rotated in a clockwise direction around the horizontal rotatable axis 108. In this way, the vertical rotation handler 104 engaged with the door handling jig (not shown) may also be horizontally rotated in a clockwise direction (e.g., to match the plane face of the target door). Further, in this example, when the pitch adjustment component 112 is actuated to the in position, the horizontal rotation handler 120 can be horizontally rotated in a counter-clockwise direction around the horizontal rotatable axis 108.

In one aspect, the exemplary jig manipulator may be used to manipulate a door handling jig. In one implementation of this aspect, a door handling jig can be used to engage with a cumbersome door (e.g., one not easily handled by one or two people), and/or a door that presents a safety hazard (e.g., proximate to a temperature-related, chemical-related, and/or radiation-related hazard). As an example, an industrial furnace/oven (e.g., in a coke processing plant) can typically comprises a plurality of access doors, which can be used to access portions of the interior of the furnace (e.g., for operations, maintenance, loading, unloading, etc.). In this example, a door handling jig, configured to engage with a furnace door, may be used to open, close, and/or remove and replace the door. Further, in this example, the exemplary jig manipulator may be used to manipulate a door handling jig to facilitate the opening, closing, and/or removal and replacement of the door.

As an illustrative example, the access doors to industrial furnaces can comprise a type of insulating material applied to an inside of the door. For example, refractory material is often applied to an interior of a metal door to mitigate heat loss, and/or to mitigate damage (e.g., melting) to the door. In this example, when the insulating material reaches the end of its useful operation (e.g., is no longer providing appropriate insulation to the door) an operator may wish to remove and replace the door and/or insulation. Further, some industrial furnaces can remain in near constant operation, even during times of door replacement.

As an example, when a door's insulation is no longer useful, the door may become very hot (e.g., glow red-hot), indicating a need for replacement of the insulation and/or door. In this example, an operator may wish to remove and replace the door quickly and safely, as the furnace operation may provide an unsafe condition, and heat-loss may be crucial during the furnaces operation. In one implementation, the door handling jig may be engaged with the exemplary jig manipulator, which may be engaged with an appropriate crane (e.g., a hydraulic extension crane). In this implementation, for example, the operator can utilize the crane, exemplary jig manipulator, and door handling jig to safely and quickly remove and replace the door.

Some furnace doors may weigh in excess of twelve thousand pounds and may be twelve feet long or more. Further, an area of operation (e.g., space available to access the doors) may be quite limited in some industrial applications. As an example, the operator may identify a door that needs to be replaced. The operator can mobilize the crane, with the attached jig manipulator and door jig, to the site of the door. The crane may locate proximate to the door, and the jig manipulator can be manipulated in both the vertical and horizontal rotation axes, thereby engaging the door handling jig with the door in a more efficient manner (e.g., more quickly and safely). In this example, the target door can be quickly removed from the furnace using the crane, jig manipulator and door jig; and a replacement door may be quickly installed using the crane, jig manipulator and door jig. Previously door removal and replacement may have taken thirty minutes or more, leading to potentially unsafe conditions and/or critical heat-loss. Utilizing the jig manipulator, removal and replacement may merely take five minutes, for example, as the door handing jig can be quickly engaged with the target door, unlike previous door removal techniques.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Of course, those skilled in the art will recognize many modifications may be made to this configuration without departing from the scope or spirit of the claimed subject matter.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. A jig manipulator comprising:
a first end;
a second end;
a crane engagement means configured to selectively engage the jig manipulator with at least a portion of a crane at the first end; and
a jig engagement means configured to engage a component handling jig with the jig manipulator at the second end.

2. The jig manipulator of claim 1, the crane engagement means comprising a male connector configured to selectively engage with a corresponding female portion of the crane.

3. The jig manipulator of claim 1, the jig engagement means comprising a plate configured to selectively engage with the component handling jig.

4. The jig manipulator of claim 1, the jig engagement means comprising a plate configured to be fixedly engaged with the component handling jig.

5. The jig manipulator of claim 1, comprising a vertical rotation handler, operably coupled with the jig engagement means, and configured to provide for adjustment of the yaw of the jig around a vertical axis.

6. The jig manipulator of claim 5, the vertical rotation handler comprising a vertical pivot coupler, aligned along the vertical axis, and configured to operably couple with the jig manipulator in vertical rotation around the vertical axis.

7. The jig manipulator of claim 5, the vertical rotation handler operably coupled with a horizontal rotation handler at the vertical axis, the horizontal rotation handler configured to provide for adjustment of pitch of the jig around a horizontal axis.

8. The jig manipulator of claim 5, the vertical rotation handler comprising a mechanical stop configured to mitigate over-rotation of the jig past a desired angle of rotation.

9. The jig manipulator of claim 1, comprising a horizontal rotation handler configured to provide for adjustment of pitch of the jig around a horizontal axis.

10. The jig manipulator of claim 9, the horizontal rotation handler comprising a horizontal pivot coupler, aligned along the horizontal axis, and configured to operably couple with the manipulator in horizontal rotation around the horizontal axis.

11. The jig manipulator of claim 9, the horizontal rotation handler operably coupled to a pitch adjustment component configured to adjust the pitch of the horizontal rotation handler around the horizontal axis.

12. The jig manipulator of claim 1, comprising a pitch adjustment component, operably coupled with a horizontal rotation handler, and configured to adjust the pitch of the horizontal rotation handler around a horizontal axis.

13. The jig manipulator of claim 12, comprising a structural support component, operably coupled with the pitch adjustment component and the crane engagement means, and configured to provide structural support for a target component of the jig, when the target component is selectively engaged with the jig, and the jig is engaged with the jig engagement means.

14. The jig manipulator of claim 1, comprising a hydraulic component, operably couple with the jig engagement means and a hydraulic power supply, and configured to adjust a position of the jig.

15. A jig handling device for manipulating a jig configured to engage a target component for manipulation of the target component, comprising:
a crane engagement component configured to selectively couple the device with at least a portion of a crane;
a structural support component, fixedly engaged with the crane engagement component, and configured to provide structural support during manipulation of the target component; and
a jig engagement component, operably engaged with the structural support component, and configured to engage with the jig such that manipulation of the crane results in a corresponding manipulation of the jig.

16. The device of claim 15, comprising a vertical rotation handler, operably coupled with the jig engagement component and the structural support component, and configured to provide for yaw adjustment of the jig around a vertical axis.

17. The device of claim 16, comprising a horizontal rotation handler, operably coupled with the vertical rotation handler and the structural support component, and configured to provide for pitch adjustment of the jig around a horizontal axis.

18. The device of claim 17 comprising a pitch adjustment component, operably coupled with the horizontal rotation handler and the structural support component, and configured to adjust the pitch of the horizontal rotation handler around the horizontal axis.

19. The device of claim 15, comprising a hydraulic operation component, operably coupled with the jig engagement component and a hydraulic power supply, and configured to adjust a position of the jig using hydraulic power.

20. An apparatus for manipulating a component handling jig, comprising:
a crane engagement component, comprising a male connector configured to selectively engage with a boom portion of a crane;
a structural support component, operably coupled with the crane engagement component, and configured to provide structural support during handling of a door;
a horizontal rotation handler, pivotally coupled with the structural support component in a horizontal axis of rotation, and configured to provide for pitch adjustment of the jig around the horizontal axis;
a pitch adjustment component, pivotally coupled with the horizontal rotation handler and the structural support component, and configured to adjust the pitch of the horizontal rotation handler around the horizontal axis;
a vertical rotation handler, pivotally coupled with the horizontal rotation handler in a vertical axis of rotation, and configured to provide for yaw adjustment of the jig around the vertical axis; and
a jig engagement component, fixedly engaged with the vertical rotation handler, and configured to engage with the jig.
